(19) United States
(12) Patent Application Publication
(10) Pub. No.: US 2005/0214722 A1
(43) Pub. Date: Sep. 29, 2005

(54) Language online learning system and method integrating local learning and remote companion oral practice

(76) Inventors: Sayling Wen, Taipei (TW); Zechary Chang, Taipei (TW); Pinky Ma, Beijing (CN)

Correspondence Address: BIRCH STEWART KOLASCH & BIRCH, PO BOX 747, FALLS CHURCH, VA, 22040-0747, US

(21) Appl. No.: 10/806,091

(22) Filed: Mar. 23, 2004

(51) Int. Cl. G09B 19/00

(52) U.S. Cl. 434/156; 434/350

(57) ABSTRACT

A learning system and method applies computer network and achieves an online language learning through integration of local learning and remote companion oral practice. The local user selects a curriculum topic from a database for learning. A user-mating module establishes network connections according to the online user status. A curriculum-coding module encodes the characteristics of the curriculum contents and transfers the characteristic codes to the remote user site. A curriculum-decoding module at the remote user site receives and decodes the characteristic codes to generate correspondent curriculum pages. A page synchronization module returns and updates the curriculum pages for the users. Therefore, the local and remote users take oral practices on the curriculum pages through audio/video communication.

### BACKGROUND OF THE INVENTION

1. Field of the Invention

The invention generally relates to a language learning system and method, and in particular relates to an online companion language learning system and method integrating local learning and remote user oral practice.

2. Related Art

Foreign language is an essential tool to learn and share information of international culture and science knowledge and to achieve communication. In the competition and fellowship of international affairs, language always plays a role of intercommunication among countries and crossing over boundaries.

In accompany with global developments of economic affairs and scientific technology, language, especially oral communication, is extremely practical and useful. Oral communication is not a simple comprehension or static knowledge, but a dynamic and interactive process of information intercommunication. Speaking of a language is a capability of the speaker that reflects the achievement of description, response, phrase using, mood, accent and so on. In order to obtain techniques of language speaking, one has to be happy to learn and to speak and practice frequently.

There are some foreign language training schools that provide curriculums of oral training for small class participants. Though the participants have chance to interact with others, intensive individual instructions cannot be provided to the students because teachers are limited.

As computer and multimedia technologies being developed, people try to use computer for helping their language learning. Some real-time and interactive communication are made. However, most training media are just of real voice dialogue plays. Some online oral practices are users taking free talks without certain topics. Because of the free talks, the achievement of learning cannot be measured. For learning a language, some major fields such as work, life or entertainment, can be specified; further some detailed scenes, such as talking on trades or talking for interview or others, can be provided. When online participants take only free talks, they don't have a distinct topic to practice and cannot get an effective learning. Therefore, it is a demand to apply computer network technology to language-learning that the users not only practice on specific topics but also enjoy online interactive oral practices. The ideal learning system provides online conversation and achievement measurements so that the users can notice their insufficiency and take effective practices.

### SUMMARY OF THE INVENTION

The object of the invention is to provide a language learning system and method that integrates local and remote online users for real-time oral practice through computers. The system and method helps the users practice talking on a certain topic and accomplish the learning. It also monitors the user's achievement and instructs the user to improve the learning.

A learning system according to the invention applies computer network and achieves an online language-learning through integration of local learning and remote companion oral practice. The users can take online oral practices and intercommunication based on the curriculum contents. The system includes a curriculum database for storing multimedia contents (text and pictures, etc.) of at least a curriculum topic for the users to refer during talking; a local learning module for getting correspondent contents from the database according to the selected curriculum topic; a curriculum coding module for encoding the characteristics of the current curriculum contents; a user-mating module for establishing the user connections and transferring the characteristic codes to the remote user site; a curriculum decoding module for receiving and decoding the characteristic codes to generate correspondent curriculum pages; a page synchronization module for returning and updating the curriculum pages for the user; and a remote communication module at each site for providing oral intercommunicating on the curriculum pages through audio/video communication of the users.

According to the invention, a learning method for providing local learning and remote online oral practices through a computer network includes the following steps. First, the user chooses a curriculum topic for oral practice from a curriculum database. Then, establishing a user connection between the local user and an online user according to the user status; encoding the curriculum content characteristics and transferring the codes to the remote user site. At the remote user site, decoding the characteristic codes to generate correspondent curriculum pages; and returning and updating the curriculum pages to the connected users. Finally, providing oral intercommunication via audio/video signal interchange for the users to practice the curriculum contents.

The learning system and method integrating local learning and remote user online oral practices according to the invention synchronizes the curriculum contents for the users to learn. The user can choose his or her favorite topic and request to establish online communication with a companion on the network who likes the same topic so as to increase the interests and funs of learning. It improves the learning efficiency and also helps checking of the learning achievement so that the users can know their insufficiencies and improve their further learning.

### BRIEF DESCRIPTION OF THE DRAWINGS

The invention will become more fully understood from the detailed description given herein below. However, this description is for purposes of illustration only, and thus is not limitative of the invention, wherein:

FIG. 1 is a block diagram of a language learning system of the invention that integrates local and remote online users for real-time oral practice through a network;

FIG. 2a is a is a main flowchart of a language learning method of the invention that integrates local and remote online users for real-time oral practice through a network;

FIG. 2b is a flowchart of a language learning method of the invention in checking the learning achievement;

FIG. 2c is a flowchart of a language learning method of the invention in connecting the online users; and

FIGS. 3A to 3E are examples of intercommunication pages in an embodiment of the invention.

### DETAILED DESCRIPTION OF THE INVENTION

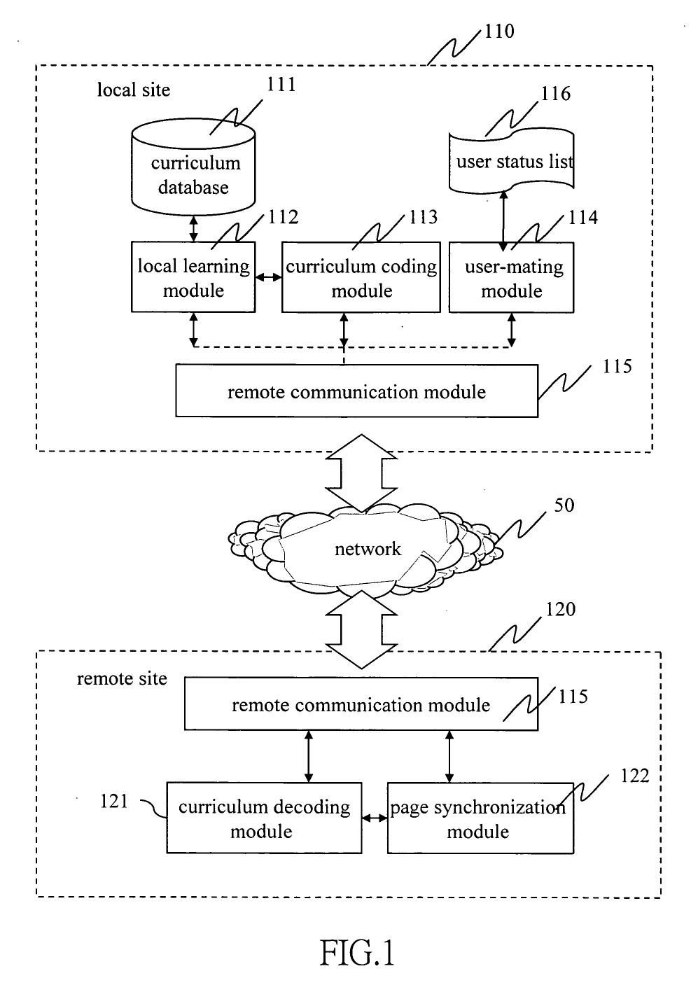

As shown in FIG. 1, a language learning system and method of the invention integrates a local site 110 and a remote site 120 through a network 50. The local user and the remote user take online oral practices and intercommunication via a remote communication module 115 at each site. The language learning system includes the following components:
1) a curriculum database 111 for storing multimedia contents (text and pictures, etc.) of at least a curriculum topic for the users to refer during talking;
2) a local learning module 112 for getting correspondent contents from the database 111 according to the curriculum topic selected by the user;
3) a curriculum coding module 113 for coding the characteristics of the current curriculum contents based on the user's learning history and consensus; the curriculum coding module 113 encodes the curriculum contents in order to transfer through the network 50;
4) a user-mating module 114 for establishing a user connection based on the user selection from a user status list 116 provided by the system, and transferring the characteristic codes from the local site 110 to the remote site 120; the user-mating module 114 includes a user management unit for maintaining a list of registered users and generating the user status list 116 that includes labels of user status as “busy”, “idle” or “offline”, and labels of user categories as “teacher” or “student”; the online users can choose their companions for oral practices according to the user categories; the user management unit also provides reservations that a user can send a reservation request for a user in talking so as to establish intercommunication after the being-reserved user finishes the talking; or, to be informed of being reserved if the user is originally offline, and then to be connected for intercommunication;
5) a curriculum decoding module 121 at the user site for receiving and decoding the characteristic codes to generate correspondent curriculum pages;
6) a page synchronization module 122 for returning and updating the curriculum pages for the connected users; and
7) a remote communication module 115 at each site for providing oral intercommunicating on the curriculum pages through audio/video communication of the users.

The learning system further includes a achievement-checking module, connecting with the remote communication module 115 for comparing the speech waveforms of the user's speech to the waveform of correspondent speech data in the database 111 so as to provide an achievement result of learning.

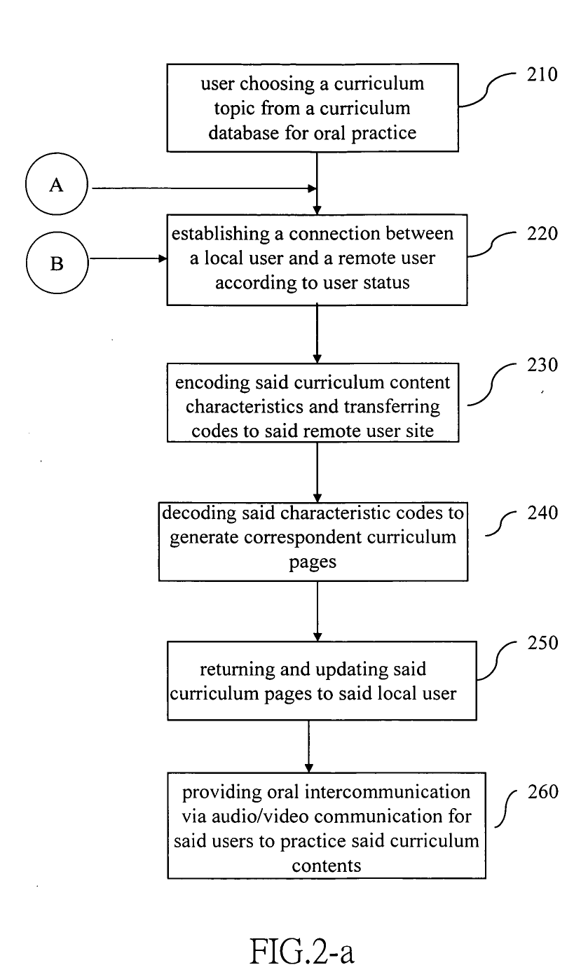

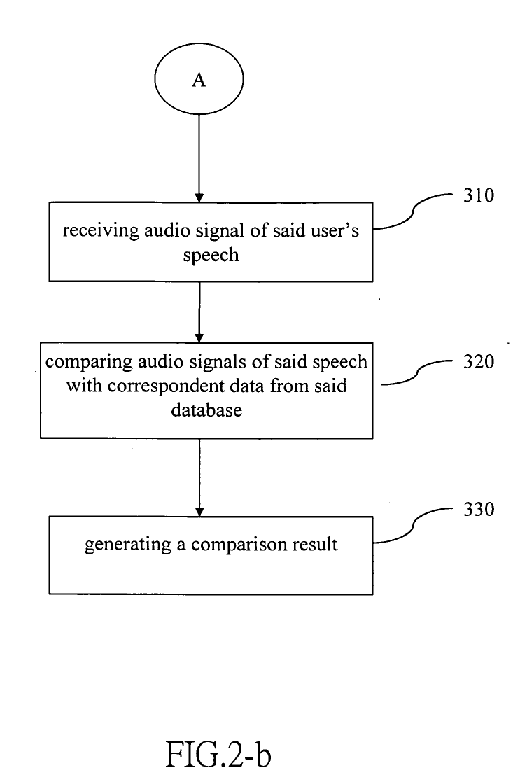

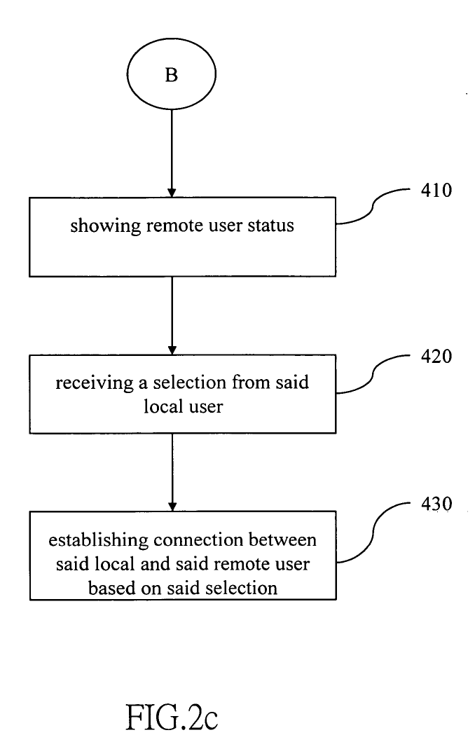

FIG. 2a is a main flowchart of a language learning method of the invention that integrates local and remote online users for real-time oral practice through a network. The method includes the following steps. First, the user chooses a curriculum topic for oral practice from a curriculum database (step 210). Then, establishing a user connection between the local user and an online user according to the user status (step 220); encoding the curriculum content characteristics and transferring the codes to the remote user site (step 230). At the remote user site, decoding the characteristic codes to generate correspondent curriculum pages (step 240); and returning and updating the curriculum pages to the connected users (step 250). Finally, providing oral intercommunication via audio/video signal interchange for the users to practice the curriculum contents (step 260).

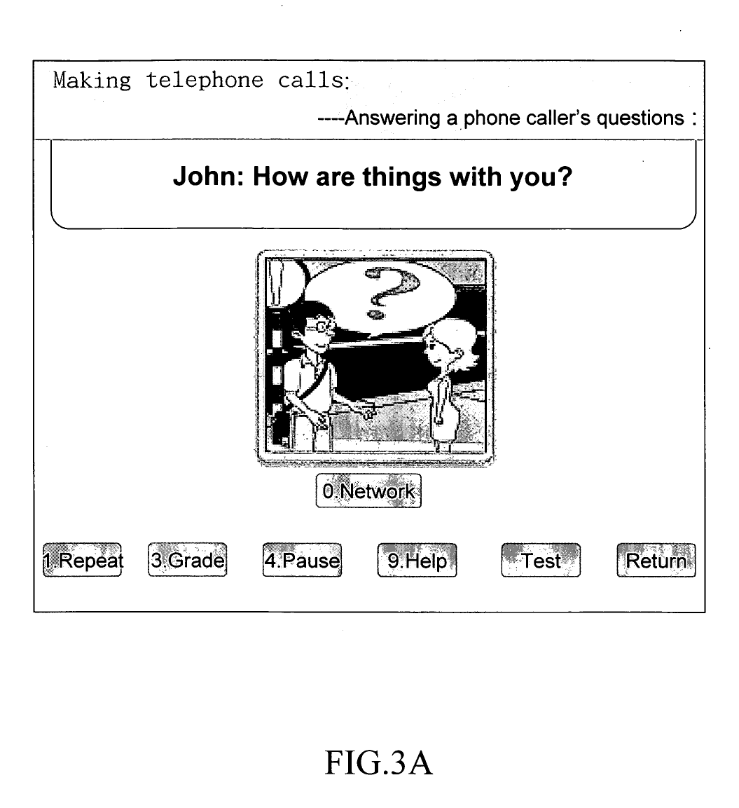

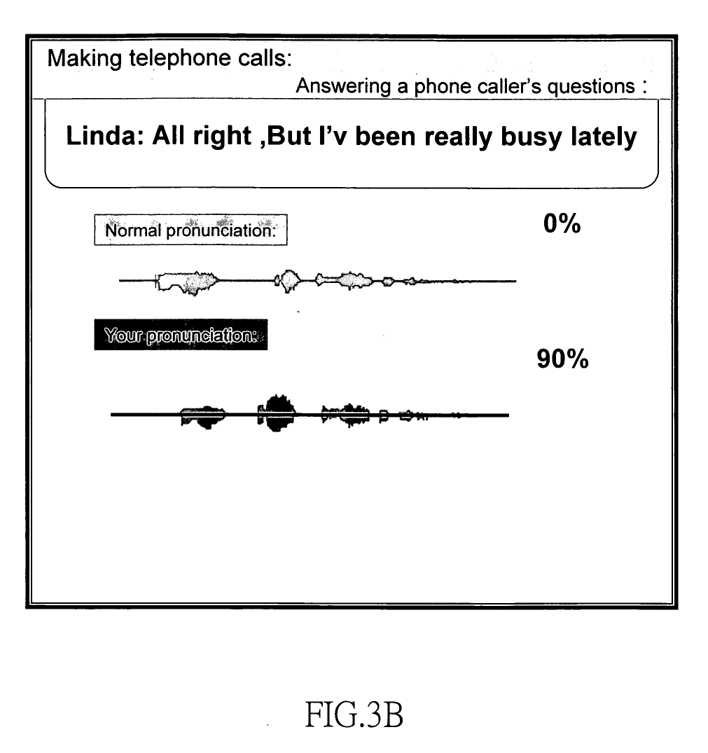

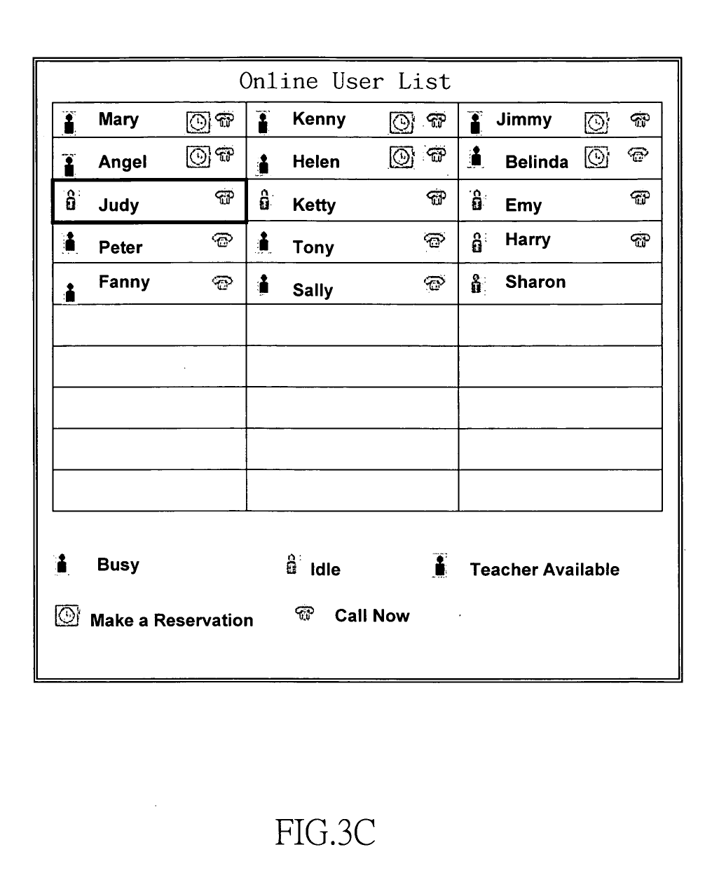

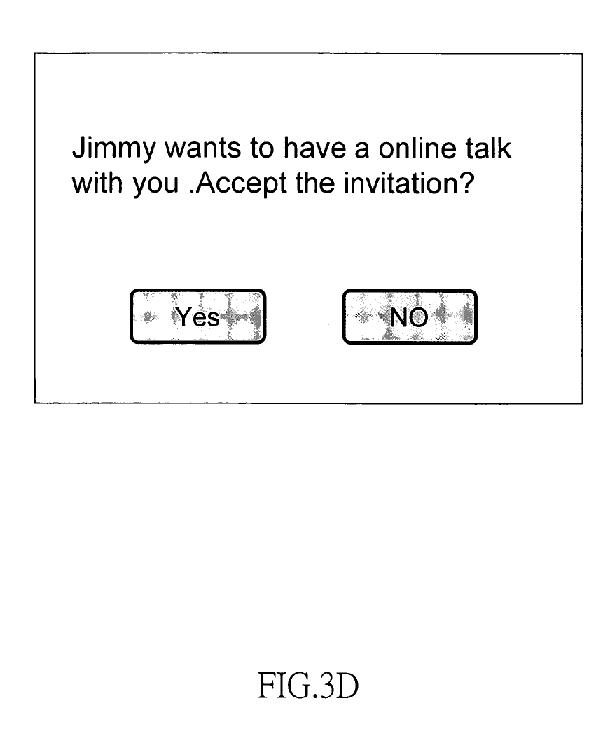

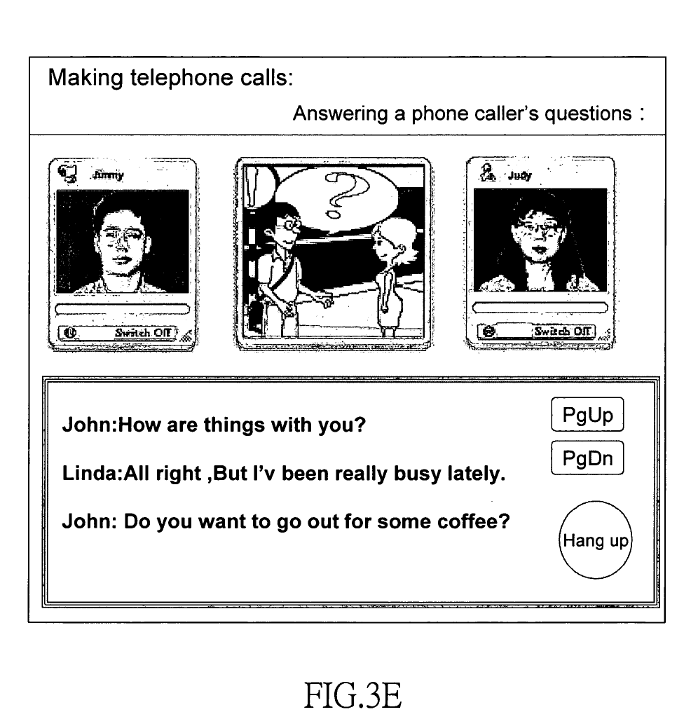

FIGS. 3A to 3E are examples of intercommunication pages in an embodiment the invention. Please refer to FIG. 2b and FIG. 3A. The user can practice with the curriculum contents himself or herself before entering the network. After practicing the contents speech, the user can check the speech achievement as shown in FIG. 3B. The procedure of checking the user's learning achievement is shown in the flowchart of FIG. 2b. First, receiving audio signal of the user's speech (step 310). Then, comparing audio signals of the speech and the correspondent data from the database (step 320). Finally, generating the comparison result (step 330). After confirming the achievement, the user can enter the network by clicking the “network” button, as shown in FIG. 3A, for preparing intercommunication with other users. The procedure of establishing the user connection is illustrated in the flowchart of FIG. 2c. First, showing a user status list (step 410) as shown in FIG. 3C in which the users are labeled as “busy”, “idle” or “offline”, and “reserved” or not. The users are also classified into “student” or “teacher” (The teachers are users who have been certified through a certification process). Then, the local user invites a connection with a remote user (step 420) as shown in FIG. 3D. Finally, the local and remote connection is established based on the invitation and the acceptance of the remote user (step 430). If the remote user is offline, a reservation can be made. After confirming the curriculum through connection with audio/video signals, the users can proceed oral practices of the curriculum contents. The system encodes the content characteristics and sends to the remote user site where the contents are decoded and retrieved into curriculum pages. The pages are returned and updated for the users to refer. Then, the users take online talks on the curriculum pages through audio/video communication (as shown in FIG. 3E). The process increases the interests and funs of learning. It improves the learning efficiency of users who talk on the specific curriculum topics.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A learning system applicable to a computer network for achieving an online language learning through integration of local learning and remote companion oral practice among a plurality of users, comprising at least:
a curriculum database, for storing multimedia contents composed of text and pictures of at least a curriculum topic for users to refer during talking;
a local learning module, for getting correspondent curriculum contents from said database according to a curriculum topic selected by a local user;
a curriculum coding module, for coding characteristics of said curriculum contents;
a user-mating module, for establishing user connections and transferring said characteristic codes to a remote user site;
a curriculum decoding module, for receiving and decoding said characteristic codes to generate correspondent curriculum pages;
a page synchronization module, for returning and updating said curriculum pages for said users; and
a remote communication module at each site for providing oral intercommunicating on said curriculum pages through audio/video communication of said users.

2. The learning system for achieving an online language learning through integration of local learning and remote companion oral practice according to claim 1 further comprises a achievement-checking module, connecting with said remote communication module for comparing speech waveforms of said user's speech to waveforms of correspondent speech data in said database so as to provide an achievement result of learning.

3. The learning system for achieving an online language learning through integration of local learning and remote companion oral practice according to claim 1 wherein said user-mating module further comprises a user management unit for maintaining a list of registered users and generating a user status list.

4. The learning system for achieving an online language learning through integration of local learning and remote companion oral practice according to claim 3 wherein said user status comprises at least “busy”, “idle” and “offline”.

5. The learning system for achieving an online language learning through integration of local learning and remote companion oral practice according to claim 3 wherein said user management unit further provides reservations that a user can send a reservation request for another user.

6. The learning system for achieving an online language learning through integration of local learning and remote companion oral practice according to claim 1 wherein said users are classified as teachers and students.

7. The learning system for achieving an online language learning through integration of local learning and remote companion oral practice according to claim 1 wherein said teachers are users who have been certified through a certification process.

8. A learning method applicable to computer network for achieving an online language learning through integration of local learning and remote companion oral practice among a plurality of users, comprising at least steps of:
user choosing a curriculum topic from a curriculum database for oral practice;
establishing a connection between a local user and a remote user according to user status;
encoding said curriculum content characteristics and transferring codes to said remote user site;
decoding said characteristic codes to generate correspondent curriculum pages;
returning and updating said curriculum pages to said local user; and
providing oral intercommunication via audio/video communication for said users to practice said curriculum contents.

9. The learning method for achieving an online language learning through integration of local learning and remote companion oral practice according to claim 8 further comprising steps of checking user's learning comprising at least steps of:
receiving audio signal of said user's speech;
comparing audio signals of said speech with correspondent data from said database; and
generating a comparison result.

10. The learning method for achieving an online language learning through integration of local learning and remote companion oral practice according to claim 8 wherein said users are classified as teachers and students.

11. The learning method for achieving an online language learning through integration of local learning and remote companion oral practice according to claim 10 wherein said teachers are users who have been certified through a certification process.

12. The learning method for achieving an online language learning through integration of local learning and remote companion oral practice according to claim 8 wherein said user status comprises online status and reservation status.

13. The learning method for achieving an online language learning through integration of local learning and remote companion oral practice according to claim 12 wherein said online status of a user is one selected from a group of “busy”, “idle” and “offline”.

14. The learning method for achieving an online language learning through integration of local learning and remote companion oral practice according to claim 12 wherein said reservation status of a user is one selected from a group of “reserved” and “unreserved”.

15. The learning method for achieving an online language learning through integration of local learning and remote companion oral practice according to claim 8 wherein said step of establishing a connection between a local user and a remote user further comprises:
showing remote user status;
receiving a selection from said local user; and
establishing connection between said local and said remote user based on said selection.
